(19) United States
(12) Patent Application Publication
(10) Pub. No.: US 2017/0292494 A1
(43) Pub. Date: Oct. 12, 2017

(54) Assembly for Converting Linear and Rotational Motions of a Floating Vessel to Electricity

(71) Applicant: Mauricio Borrego, Hialeah, FL (US)

(72) Inventor: Mauricio Borrego, Hialeah, FL (US)

(21) Appl. No.: 15/093,487

(22) Filed: Apr. 7, 2016

(51) Int. Cl. F03B 13/20

(52) U.S. Cl. CPC F03B 13/20

(57) ABSTRACT

An assembly for converting linear and rotational motions of a floating vessel into electrical energy. The assembly provides a floating vessel, such as a boat, and an operationally connected power generation unit that harnesses the natural buoyant movements of the vessel to generate electrical energy in the power generation unit for use by the vessel or other electrical consumption system. As the vessel moves in linear and rotational movements, the power generation unit reciprocally pivots. This pivoting motion urges a push rod in and out of the power generation unit. A piston extends from the push rod. A reservoir feeds hydraulic fluids through a closed loop system. The piston urges the hydraulic fluid into a hydraulic motor that creates a mechanical action. A generator converts the mechanical action to electrical energy. A platform pivots between a table position and a step position to provide greater functionality of the vessel.

### BACKGROUND

The following background information may present examples of specific aspects of the prior art(e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The present invention is directed to an assembly for converting linear and rotational motions of a floating vessel into electrical energy. The assembly provides a floating vessel, such as a boat, and an operationally connected power generation unit that harnesses the natural buoyant movements of the vessel to generate electrical energy in the power generation unit for use by the vessel or other electrical consumption system.

The inventor was familiar with boats, ships, and other marine vehicles. The inventor often noted that when boats went out to sea, and especially for many days, the capacity to generate electrical power was limited to the batteries on board. Often the batteries would terminate before the boat returned to shore.

The inventor recognized a problem in that electrical energy was limited on a boat. The inventor realized that electrical energy could be generated on the boat, so that the dependence on batteries was reduced.

Through additional research, the inventor learned that the buoyant movement of a boat resulted in linear and rotational movements. The linear motions may include a heave, a sway, and a surge. The heave is the linear vertical up and down motion by the vessel. The sway is the linear lateral, side-to-side motion. The surge is the linear longitudinal, front to back motion often imparted by maritime conditions. The linear motion provides at least a portion of the kinetic energy used to produce the electrical energy.

Through research, the inventor also learned that rotational motions may include a pitch, a roll, and a yaw. The pitch is the up and down rotation of a vessel about its lateral, Y, or side-to-side axis. The roll is the tilting rotation of a vessel about its longitudinal, X, or front-to-back axis. The yaw is the turning rotation of a vessel about its vertical, or Z axis. The rotational motion provides at least a portion of the kinetic energy used to produce the electrical energy. The inventor wondered if the linear and rotational movements could be harnessed to generate the electrical energy.

The inventor attached a power generation unit that could convert mechanical action to electrical power. The inventor realized that the mechanical action would come from the linear and rotational movements of the boat. The inventor then pivotally attached the power generation unit to the boat. Thus, the power generation unit pivoted in reciprocation to the boat.

However, this still did not create the linear type of motion required to create mechanical action for generating electrical energy. The inventor added a piston in an axial disposition to a push rod. The push rod moved axially in relation to the pivoting power generation unit. The piston forcibly urged a hydraulic fluid through the power generation unit in a closed loop system.

The inventor knew that hydraulic motors could be actuated to create a mechanical action. The inventor added a hydraulic motor in the closed loop system so that the high velocity hydraulic fluid would actuate the hydraulic motor. The inventor next operatively connected a generator to the hydraulic motor. The inventor knew that generators converted mechanical action to electrical energy. Finally, to more efficiently harness the electrical power, the inventor added a voltage regulator and wired the voltage regulator to the battery on the boat for recharging.

For the foregoing reasons, there is an assembly for converting linear and rotational motions of a floating vessel into electrical energy.

Electrical generating systems that used linear, rotational, and wave movements to generate electricity have been utilized in the past; yet none with the characteristics of the present invention, See U.S. Pat. Nos. 3,259,361; 8,026,620; and 8,779,613.

For the foregoing reasons, there is an assembly for converting linear and rotational motions of a floating vessel into electrical energy. The assembly provides a floating vessel, such as a boat, and an operationally connected power generation unit that harnesses the natural buoyant movements of the vessel to generate electrical energy in the power generation unit for use by the vessel or other electrical consumption system.

### SUMMARY

The present invention describes an assembly for converting linear and rotational motions of a floating vessel into electrical energy. The assembly comprises a floating vessel, such as a boat, that has sufficient buoyancy to float on a liquid. While floating, the vessel experiences at least one linear motion and at least one rotational motion associated with buoyancy.

In some embodiments, the linear motions may include a heave, a sway, and a surge.

The heave is the linear vertical up and down motion by the vessel. The sway is the linear lateral, side-to-side motion. The surge is the linear longitudinal, front to back motion often imparted by maritime conditions. The linear motion provides at least a portion of the kinetic energy used to produce the electrical energy.

In some embodiments, the rotational motions may include a pitch, a roll, and a yaw. The pitch is the up and down rotation of a vessel about its lateral, Y, or side-to-side axis. The roll is the tilting rotation of a vessel about its longitudinal, X, or front-to-back axis. The yaw is the turning rotation of a vessel about its vertical, or Z axis. The rotational motion provides at least a portion of the kinetic energy used to produce the electrical energy. The linear and rotational movements are harnessed to generate the electrical energy.

The assembly further comprises a power generation unit. The power generation unit is defined by a unit housing and a unit cavity. The power generation unit is configured to translate the linear and rotational motions of the vessel into the electrical energy. The power generation unit operatively connects to the vessel at a pivot connection. The pivot connection enables the power generation unit to pivotally move in a reciprocating manner to the vessel.

The power generation unit further comprises a ballast that serves as a counterweight to the vessel, maintaining the power generation unit in a generally balanced relationship with the vessel. The ballast may be filled with a fluid to achieve a predetermined weight. The predetermined weight of the ballast may be adjusted to maintain the power generation unit in a generally balanced relationship with the vessel.

The power generation unit further comprises at least one buoyant member. The buoyant member enables the power generation unit to remain buoyant above the liquid surface, so as to oppose the weight of the ballast.

As discussed above, the vessel moves in both linear and rotational motions associated with buoyancy on the liquid. The power generation unit is configured to translate the linear and rotational motions of the vessel into an axial motion through a push rod that extends between the floating vessel and the power generation unit. The push rod is in a spaced-apart relationship with the pivot connection.

As the power generation unit pivots about the vessel, the push rod is axially displaced in a generally in-and-out motion through the unit cavity of the power generation unit. Thus, as the vessel experiences the linear and rotational motions associated with floatation, the push rod is axially displaced in a reciprocating relationship with the vessel, in and out of the power generation unit.

The unit cavity of the power generation unit comprises a reservoir that is defined by a reservoir cavity, a reservoir inlet, and a reservoir outlet. The reservoir cavity is configured to contain a hydraulic fluid.

The reservoir is in communication with a piston chamber through a first conduit. The piston chamber is defined by a chamber cavity, a chamber inlet, and a first chamber outlet and a second chamber outlet. The first conduit comprises at least one primary check valve that is disposed between the reservoir and the piston chamber. The primary check valve enables passage of the hydraulic fluid in a single direction, from the reservoir to the piston chamber. In this manner, the piston chamber receives a constant supply of hydraulic fluid from the reservoir.

Returning now to the push rod, a piston extends in an axial relationship from the push rod to the chamber cavity of the piston chamber. The piston is sized and dimensioned to form a snug concentric fit inside the chamber cavity of the piston chamber. The piston is also configured to reciprocate axially along the length of the piston chamber.

As the push rod is displaced by the movements of the vessel into the unit cavity of the power generation unit, the piston is urged into the chamber cavity. The displacement of the piston causes the hydraulic fluid, which is contained in the chamber cavity, to be forcibly discharged through the first chamber outlet at a high velocity.

Conversely, when the piston is retracted from the chamber cavity, the hydraulic fluid is forcibly discharged through the second chamber outlet at a high velocity. Thus the reciprocating in-and-out movement of the piston serves to pump the hydraulic fluid at a high velocity out of the chamber cavity.

A second conduit carries the forcibly discharged hydraulic fluid from the first and second chamber outlets of the piston chamber to a hydraulic motor. The second conduit comprises at least one secondary check valve. The secondary check valve is disposed between the piston chamber and the hydraulic motor. The secondary check valve enables passage of the hydraulic fluid in a single direction, from the piston chamber to the motor inlet of the hydraulic motor.

The hydraulic motor is defined by a motor cavity, a motor inlet, and a motor outlet. The hydraulic motor is configured to operatively join with a generator that is configured to convert mechanical action into electrical energy. The hydraulic motor is configured to translate the pressure of the incoming high velocity hydraulic fluid into a mechanical action. The mechanical action is operable to actuate the generator, as the generator converts the mechanical action into electrical energy. The electrical energy may then be harnessed through a voltage regulator and wiring, so as to feed a battery.

Further, as hydraulic fluid flows at a high velocity into the motor cavity of the hydraulic motor, the spent hydraulic fluid in the motor cavity is discharged through the motor outlet. A third conduit carries the spent hydraulic fluid from the motor outlet to the reservoir through the reservoir inlet, so as to continue the cycle through the power generation unit.

In one alternative embodiment, the assembly further comprises a platform that provides a stable surface area for selectively working on the vessel or boarding and off boarding the vessel. The platform pivotally articulates between a table position, which is configured to provide a support approximately above the vessel to provide a work surface. The platform may also move to a step position is configured to provide a stepping support along the sides of the vessel to enable boarding and off boarding of the vessel.

The assembly further comprises an arm that supports the platform. The arm is defined by a first end and a second end. The first end pivotally joins with the housing of the power generation unit at an arm pivot connection. The second end fixedly joins with a platform. The arm is configure to pivotally articulate in relation to the vessel, so as to move the platform between the table position and the step position.

In one aspect, an assembly for converting linear and rotational motions by a floating vessel to electrical energy, comprises:
a vessel defined by a generally buoyant configuration, the vessel configured to move in at least one linear motion and at least one rotational motion associated with buoyancy;
a power generation unit defined by a unit housing and a unit cavity, the power generation unit disposed to operatively join with the vessel, the power generation unit configured to enable conversion of the at least one linear motion and the at least one rotational motion of the vessel into electrical energy;
a pivot connection disposed to pivotally join the power generation unit to the vessel, the pivot connection configured to enable the power generation unit to pivotally move in a reciprocating manner relative to the vessel;
a ballast disposed to join with the unit housing of the power generation unit, the ballast configured to receive a liquid, whereby the liquid weighs the ballast to a predetermined weight that maintains the power generation unit in a generally balanced relationship with the vessel;
at least one buoyant member disposed to join with the unit housing, the at least one buoyant member configured to enable buoyancy of the power generation unit, whereby the buoyancy of the at least one buoyant member opposes the predetermined weight of the ballast;
a reservoir disposed in the unit cavity, the reservoir defined by a reservoir cavity, a reservoir inlet, and a reservoir outlet, the reservoir cavity configured to contain a hydraulic fluid;
a piston chamber defined by a chamber cavity, a chamber inlet, and a first chamber outlet, and a second chamber outlet, the piston chamber in communication with the reservoir;
a first conduit configured to carry the hydraulic fluid from the reservoir to the piston chamber;
at least one primary check valve configured to enable passage of the hydraulic fluid in a single direction, from the reservoir to the piston chamber;
a push rod disposed to extend between the floating vessel and the unit housing of the power generation unit, whereby as the vessel moves in the at least one linear motion and the at least one rotational motion, the push rod is axially displaced in a reciprocating relationship with the vessel, in and out of the unit cavity of the power generation unit;
a piston disposed to extend in an axial relationship from the push rod to the chamber cavity of the piston chamber, the piston configured to be urged into the chamber cavity when the push rod is displaced into the unit cavity of the power generation unit, whereby displacement of the piston into the chamber cavity forcibly discharges the hydraulic fluid through the chamber outlet;
a hydraulic motor defined by a motor cavity, a motor inlet, and a motor outlet, the hydraulic motor configured to translate the flow of the hydraulic fluid into a mechanical action;
a generator disposed to operatively join with the hydraulic motor, the generator configured to translate the mechanical action of the hydraulic motor to an electrical energy;
a second conduit, the second conduit configured to carry the hydraulic fluid from the piston chamber to the hydraulic motor;
at least one secondary check valve configured to enable passage of the hydraulic fluid in a single direction, from the piston chamber to the motor inlet of the hydraulic motor; a voltage regulator disposed to join with the generator, the voltage regulator configured to maintain the electrical energy at a substantially constant voltage;
a battery disposed to operatively connect to the voltage regulator, the battery configured to be charged by the electrical energy;
a third conduit configured to carry the hydraulic fluid from the hydraulic motor to the reservoir;
a platform; and
an arm defined by a first end and a second end, the first end disposed to pivotally join with the unit housing of the power generation unit, the second end disposed to fixedly join with the platform, the arm configured to pivotally articulate in relation to the vessel.

In one aspect, the vessel includes at least one member selected from the group consisting of: a boat, a sail boat, a ship, a submarine, and a marine dock.

In another aspect, the at least one linear motion comprises a heave, a sway, and a surge

In another aspect, the at least one rotational on comprises a pitch, a roll, and a yaw.

In another aspect, the power generation unit is configured to form a closed loop system.

In another aspect, the at least one buoyant member is an evacuated cavity.

In another aspect, the at least one buoyant member comprises two spaced-apart evacuated cavities.

In another aspect, the ballast comprises a ballast inlet configured to receive a liquid.

In yet another aspect, the unit housing of the power generation unit comprises a plurality of fastening pegs.

In yet another aspect, the assembly further comprises a hull mounting bracket, the hull mounting bracket configured to join the vessel with the pivot connection and the push rod.

In yet another aspect, the hull mounting bracket comprises a bracket extension member.

In yet another aspect, the hull mounting bracket comprises a plurality of apertures configured to receive a fastener.

In yet another aspect, the plurality of apertures of the hull mounting bracket are configured to align with the plurality of fastening pegs of the unit housing.

In yet another aspect, the third conduit is configured to receive the hydraulic fluid from the first chamber outlet and the second chamber outlet.

In yet another aspect, the voltage regulator is a direct current voltage boost regulator.

One objective of the present invention is to convert the natural buoyant movements of a boat to electrical energy.

Another objective of the present invention is to axially displace the push rod in a reciprocating relationship with the pivoting of the power generation unit about the vessel.

Another objective of the present invention is to forcibly urge the hydraulic fluid through a closed loop system, so as to convert mechanical action into electrical energy.

Yet another objective of the present invention is to provide a convertible table and step ladder for a boat.

Yet another objective is to provide an inexpensive method for generating electrical energy on a boat.

Other systems, devices, methods, features, and advantages will be or become apparent to one with skill in the art upon examination of the following drawings and detailed description. it is intended that all such additional systems, methods, features, and advantages be included within this description, be within the scope of the present disclosure, and be protected by the accompanying claims and drawings.

### DRAWINGS

These and other features, aspects, and advantages of the present invention will become better understood with regard to the following description, appended claims, and drawings where:

FIG. 1 is an elevated side view of an exemplary assembly for converting linear and rotational motions of a floating vessel into electrical energy, in accordance with an embodiment of the present invention;

FIG. 2 is a sectioned side view of the assembly shown in FIG. 1, in accordance with an embodiment of the present invention;

FIGS. 3A and 3B are views of an exemplary hull mounting bracket, where FIG. 3A is a top plan view, and FIG. 3B is an elevated side view, in accordance with an embodiment of the present invention;

FIG. 4 is a side view of an exemplary voltage regulator and a battery, in accordance with an embodiment of the present invention;

FIG. 5 is an elevated side view of an exemplary platform positioned in a table position, in accordance with an embodiment of the present invention;

FIG. 6 is an elevated side view of the platform shown in FIG. 5 positioned in a step position, in accordance with an embodiment of the present invention; and

FIG. 7 is rear view of the platform shown in FIG. 5 positioned in the step position, in accordance with an embodiment of the present invention.

### DESCRIPTION

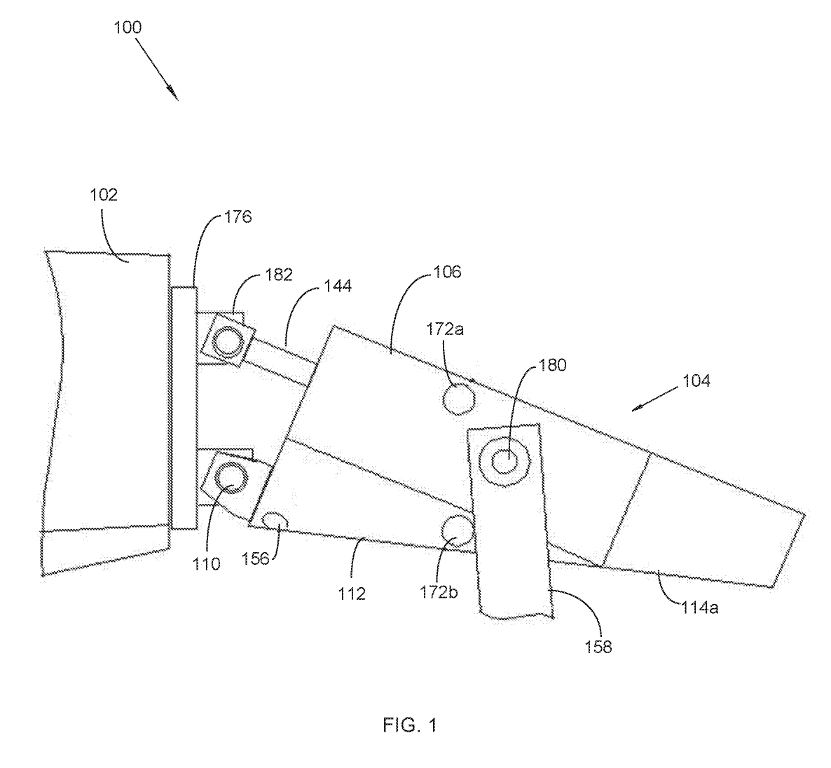

The present invention, referenced in FIGS. 1-7, is directed to an assembly 100 for converting linear and rotational motions of a floating vessel into electrical energy. The assembly 100 provides a vessel 102, such as a boat, and an operationally connected power generation unit 104 that harnesses the natural buoyant movements of the vessel 102 to generate electrical energy in the power generation unit 104 for use by the vessel 102 or other electrical consumption system.

As FIG. 1 references, the vessel 102 may include, without limitation, a boat, a sail boat, a ship, a submarine, and a marine dock. The vessel 102 is substantially hollow, so as to have buoyant characteristics on a liquid surface. While buoyant on the liquid surface, the vessel 102 experiences at least one linear motion and at least one rotational motion associated with buoyancy.

In some embodiments, the linear motions may include a heave, a sway, and a surge. The heave is the linear vertical up and down motion by the vessel 102. The sway is the linear lateral, side-to-side motion. The surge is the linear longitudinal, front to back motion often imparted by maritime conditions. The linear motion provides at least a portion of the kinetic energy used to produce the electrical energy.

In some embodiments, the rotational motions may include a pitch, a roll, and a yaw. The pitch is the up and down rotation of a vessel 102 about its lateral, Y, or side-to-side axis. The roll is the tilting rotation of a vessel 102 about its longitudinal, X, or front-to-back axis. The yaw is the turning rotation of a vessel 102 about its vertical, or Z axis. The rotational motion provides at least a portion of the kinetic energy used to produce the electrical energy. The linear and rotational movements are harnessed to generate the electrical energy. However in other embodiments, the

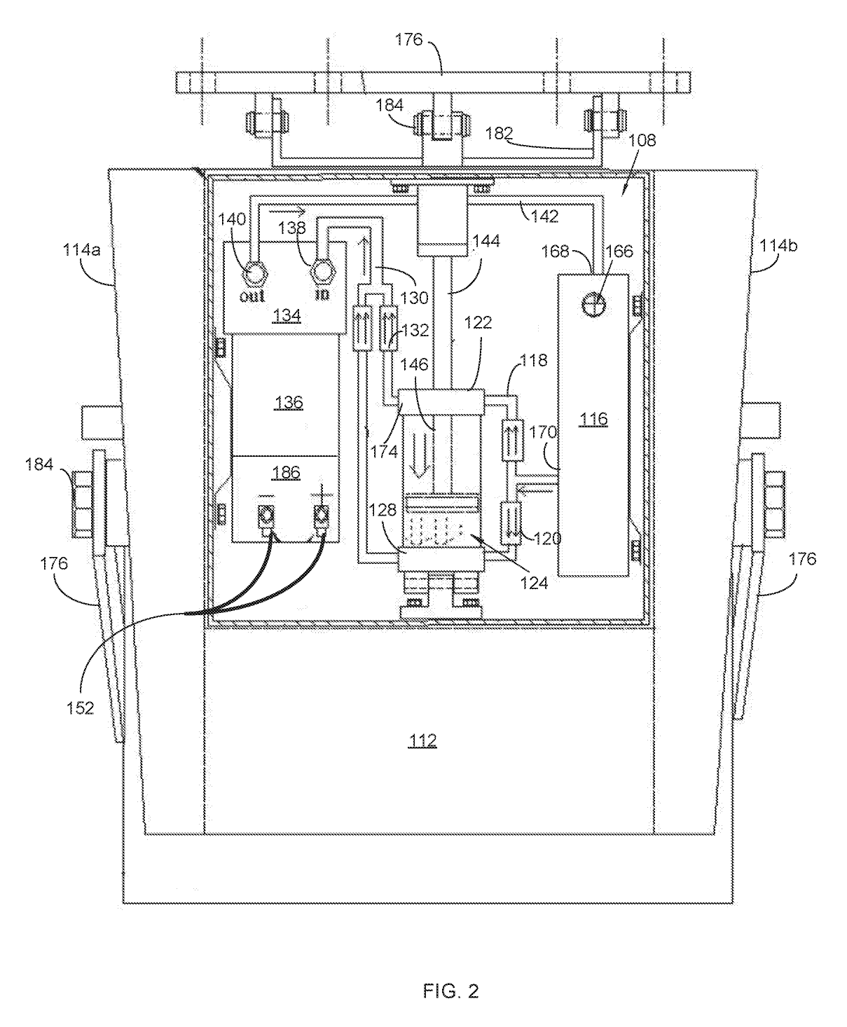

Turning now to FIG. 2, the assembly 100 further comprises a power generation unit 104, where the linear and rotational movements of the vessel 102 are harnessed to generate the electrical energy though multiple moving components therein. The power generation unit 104 is defined by a unit housing 106 and a unit cavity 108, The unit housing 106 may be shaped and dimensioned to contain the electrical energy generating components of the assembly 100. In one embodiment, the unit housing 106 comprises a generally elongated tapered shape. The unit housing 106 operatively attaches to the vessel 102 in a manner that allows the linear and rotational movements by the vessel 102 to be leveraged efficiently. In one embodiment, a plurality of fastening peg 172a, 172bs attach to the unit housing 106 to enable mounting.

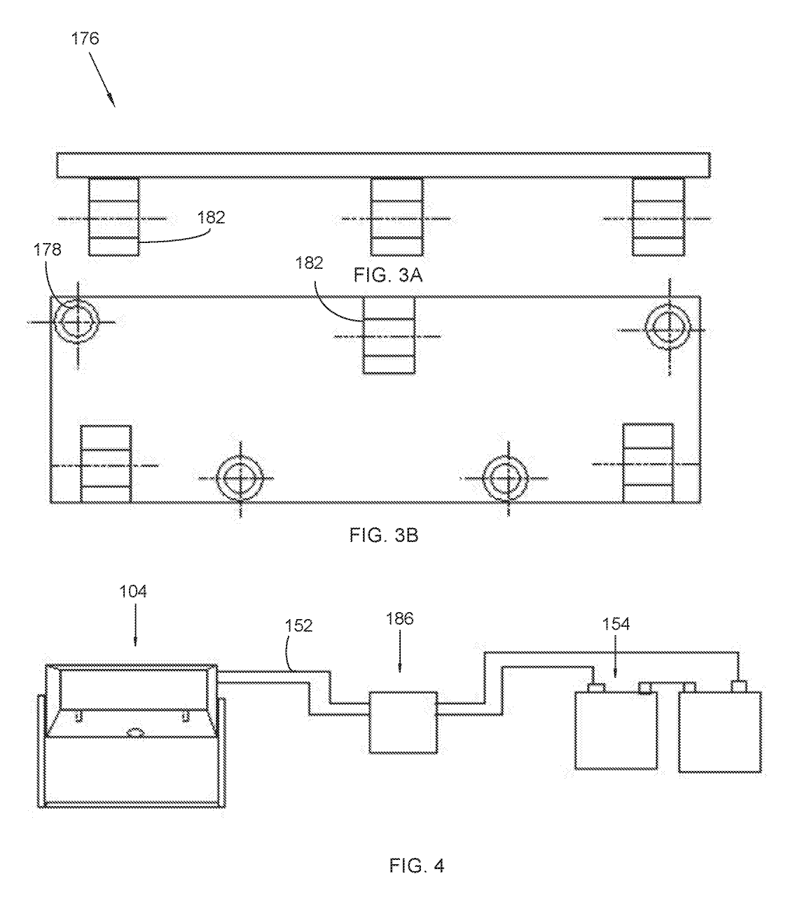

As FIGS. 3A and 3B illustrate, a hull mounting bracket 176 fastens the power generation unit 104 to the vessel 102 The hull mounting bracket 176 comprises a bracket extension member 182 that provides various fastening means to mount the power generation unit 104 to the vessel 102. In one embodiment, a plurality of apertures 178 configured to receive a fastener 184. In some embodiments, the apertures 178 may align with the plurality of fastening peg 172a, 172bs in the unit housing 106, and a fastener passes through to enable mounting thereof.

A substantial amount of the function of generating electrical energy occurs in the unit cavity 108 of the power generation unit 104. The power generation unit 104 is configured to translate the linear and rotational motions of the vessel 102 into the electrical energy. The power generation unit 104 operatively connects to the hull mounting bracket 176 at a pivot connection 110. The pivot connection 110 enables the power generation unit 104 to pivotally move in a reciprocating manner relative to the vessel 102. In some embodiments, the pivot connection 110 may include a shaft, about which the power generation unit 104 pivots.

The power generation unit 104 further comprises a ballast 112 that serves as a counterweight to the vessel 102, maintaining the power generation unit 104 in a generally balanced relationship with the vessel 102. The ballast 112 may be filled with a fluid to achieve a predetermined weight. The predetermined weight of the ballast 112 may be adjusted to maintain the power generation unit 104 in a generally balanced relationship with the vessel 102. The ballast 112 may include a ballast inlet 156 that enables passage of the liquid into the ballast 112.

The power generation unit 104 further comprises at least one buoyant member 114a, 114b. The buoyant member 114a, 114b enables the power generation unit 104 to remain buoyant above the liquid surface, so as to oppose the weight of the ballast 112, The at least one buoyant member 114a, 114b may include an evacuated cavity. In one embodiment, the at least one buoyant member 114a, 114b comprises two spaced-apart evacuated cavities. However in other embodiments, the buoyant member 114a, 114b may include a porous material, such as foam or a light polymer.

As discussed above, the vessel 102 moves in both linear and rotational motions associated with buoyancy on the liquid. The power generation unit 104 is configured to translate the linear and rotational motions of the vessel 102 into an axial motion through a push rod 144 that extends between the floating vessel 102 and the power generation unit 104. The push rod 144 is in a spaced-apart relationship with the pivot connection 110. In one embodiment, the push rod 144 is at a corner of the unit housing 106 proximal to the vessel 102.

As the power generation unit 104 pivots about the vessel 102, the push rod 144 is axially displaced in a generally in-and-out motion through the unit cavity 108 of the power generation unit 104. Thus, as the vessel 102 experiences the linear and rotational motions associated with floatation, the push rod 144 is axially displaced in a reciprocating relationship with the vessel 102, in and out of the power generation unit 104. The pivot connection 110 and the push rod 144 serve to translate the buoyant movements of the vessel 102 into linear movements that generate the electrical energy.

The unit cavity 108 of the power generation unit 104 comprises a reservoir 116 that is defined by a reservoir cavity 166, a reservoir inlet 168, and a reservoir outlet 170. The reservoir cavity 166 is configured to contain a hydraulic fluid. The hydraulic fluid serves as a medium by which power is transferred in hydraulic machinery of the power generation unit 104. The hydraulic fluid may include, without limitation an oil, a mineral oil, a lubricant and water.

The reservoir 116 is in communication with a piston chamber 122 through a first conduit 118. The first conduit 118 may include, without limitation, a tube, a pipe, a channel, and a hose. The piston chamber 122 is defined by a chamber cavity 124, a chamber inlet 126, and a first chamber outlet 128 and a second chamber outlet 174. The first conduit 118 comprises at least one primary check valve 120 that is disposed between the reservoir 116 and the piston chamber 122. The primary check valve 120 enables passage of the hydraulic fluid in a single direction, from the reservoir 116 to the piston chamber 122. In this manner, the piston chamber 122 receives a constant supply of hydraulic fluid from the reservoir 116.

The primary check valve 120 may include, without limitation, a check valve, clack valve, and a non-return valve. The primary check valve 120 is configured as a one-way valve that normally allows the hydraulic fluid (liquid or gas) to flow through it in only one direction. Those skilled in the art will recognize that check valves are two-port valves, meaning they have two openings in the body, one for fluid to enter and the other for fluid to leave.

Returning now to the push rod 144, a piston 146 extends in an axial relationship from the push rod 144 to the chamber cavity 124 of the piston chamber 122. The piston 146 is sized and dimensioned to form a snug concentric fit inside the chamber cavity 124 of the piston chamber 122. The piston 146 is also configured to reciprocate axially along the length of the piston chamber 122. In one embodiment, the edges of the piston 146 have a seal to restrict leakage of hydraulic fluid.

As the push rod 144 is displaced by the movements of the vessel 102 into the unit cavity 108 of the power generation unit 104, the piston 146 is urged into the chamber cavity 124. The displacement of the piston causes the hydraulic fluid, which is contained in the chamber cavity 124, to be forcibly discharged through the first chamber outlet 128 at a high velocity.

Conversely, when the piston 146 is retracted from the chamber cavity 124, the hydraulic fluid is forcibly discharged through the second chamber outlet 174 at a high velocity. Thus the reciprocating in-and-out movement of the piston serves to pump the hydraulic fluid at a high velocity out of the chamber cavity 124.

A second conduit 130 carries the forcibly discharged hydraulic fluid from the first and second chamber outlet 174 of the piston chamber 122 to a hydraulic motor 134. The second conduit 130 may include, without limitation, a tube, a pipe, a channel, and a hose. The second conduit 130 comprises at least one secondary check valve 132. The secondary check valve 132 is disposed between the piston chamber 122 and the hydraulic motor 134. The secondary check valve 132 enables passage of the hydraulic fluid in a single direction, from the piston chamber 122 to the motor inlet 138 of the hydraulic motor 134.

The hydraulic motor 134 is defined by a motor cavity, a motor inlet 138, and a motor outlet 140. The hydraulic motor 134 is configured to operatively join with a generator 136 that is configured to convert mechanical action into electrical energy. The hydraulic motor 134 is configured to translate the pressure of the incoming high velocity hydraulic fluid into a mechanical action. The mechanical action is operable to actuate the generator 136, as the generator 136 converts the mechanical action into electrical energy. The electrical energy may then be harnessed through a voltage regulator 186 and wiring 152, so as to feed a battery 154. The wiring between the power generation unit 104, the voltage regulator 186, and the battery 154 is referenced in the diagram of FIG. 4.

Further, as hydraulic fluid flows at a high velocity into the motor cavity of the hydraulic motor 134, the spent hydraulic fluid in the motor cavity is discharged through the motor outlet 140. A third conduit 142 carries the spent hydraulic fluid from the motor outlet 140 to the reservoir 116 through the reservoir inlet 168, so as to continue the cycle through the power generation unit 104. The third conduit 142 may include, without limitation, a tube, a pipe, a channel, and a hose.

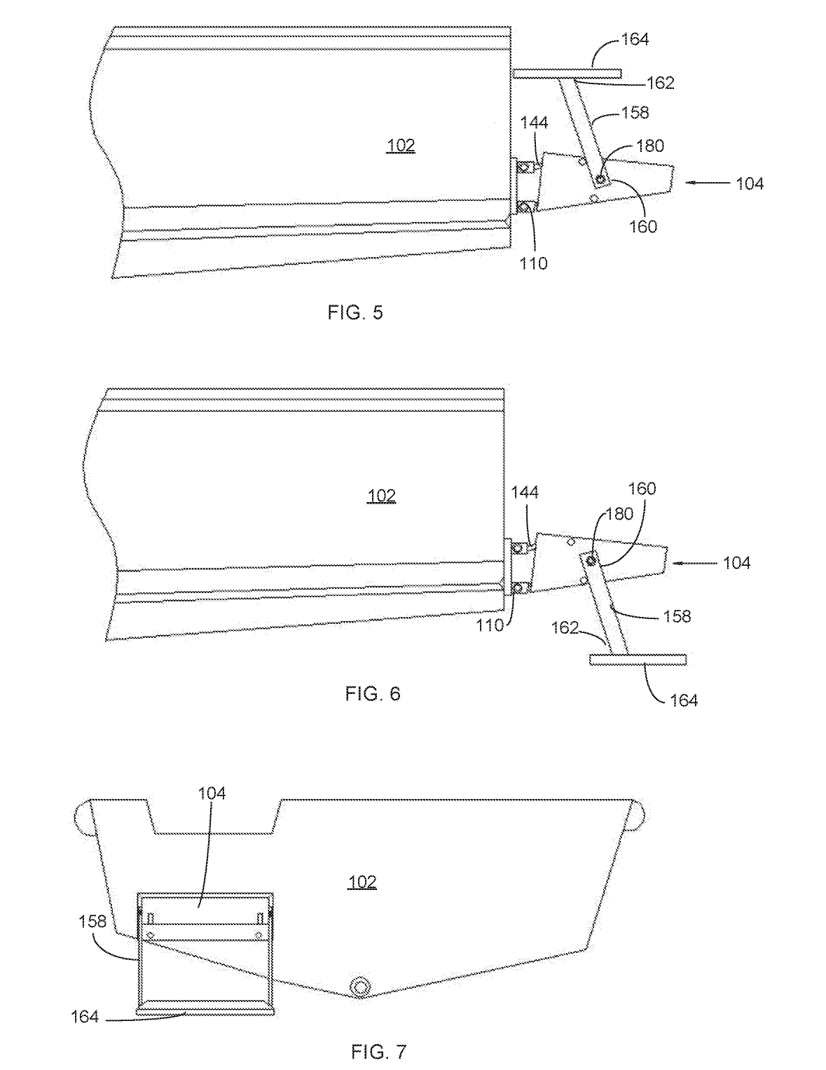

In one alternative embodiment shown in FIG. 5, the assembly 100 further includes an auxiliary component that add functionality to the vessel 102. A platform 164 is provided that forms a stable surface area for selectively working on the vessel 102. The platform 164 also provides a stable support on the sides of the vessel 102 for boarding and off boarding the vessel 102.

In one embodiment, the platform 164 pivotally articulates between a table position, which is configured to provide a support approximately above the vessel 102 to provide a work surface (FIG. 5). The platform 164 may also move to a step position is configured to provide a stepping support along the sides of the vessel 102 to enable boarding and off boarding of the vessel 102 (FIG. 6).

Looking now to FIG. 7, the assembly 100 further comprises an arm 158 that supports the platform 164. The arm 158 is defined by a first end 160 and a second end 162. The first end 160 pivotally joins with the housing of the power generation unit 104 at an arm 158 pivot connection 180, such as a shaft. The second end 162 fixedly joins with a platform 164. The arm 158 is configure to pivotally articulate in relation to the vessel 102, so as to move the platform 164 between the table position and the step position.

While the inventor's above description contains many specificities, these should not be construed as limitations on the scope, but rather as an exemplification of several preferred embodiments thereof. Many other variations are possible. For example, the platform may be detachable so as to be used in other functions, beyond a table or a step. Accordingly, the scope should be determined not by the embodiments illustrated, but by the appended claims and their legal equivalents.

What is claimed is:

1. An assembly for converting linear and rotational motions of a floating vessel into electrical energy, the assembly comprising:
a vessel defined by a generally buoyant configuration, the vessel configured to move in at least one linear motion and at least one rotational motion associated with buoyancy;
a power generation unit defined by a unit housing and a unit cavity, the power generation unit disposed to operatively join with the vessel, the power generation unit configured to enable conversion of the at least one linear motion and the at least one rotational motion of the vessel into electrical energy;
a pivot connection disposed to pivotally join the power generation unit to the vessel, the pivot connection configured to enable the power generation unit to pivotally move in a reciprocating manner relative to the vessel;
a ballast disposed to join with the unit housing of the power generation unit, the ballast configured to receive a liquid, whereby the liquid weighs the ballast to a predetermined weight that maintains the power generation unit in a generally balanced relationship with the vessel;
at least one buoyant member disposed to join with the unit housing, the at least one buoyant member configured to enable buoyancy of the power generation unit, whereby the buoyancy of the at least one buoyant member opposes the predetermined weight of the ballast;
a reservoir disposed in the unit cavity, the reservoir defined by a reservoir cavity, a reservoir inlet, and a reservoir outlet, the reservoir cavity configured to contain a hydraulic fluid;
a piston chamber defined by a chamber cavity, a chamber inlet, and a first chamber outlet, and a second chamber outlet, the piston chamber in communication with the reservoir;
a first conduit configured to carry the hydraulic fluid from the reservoir to the piston chamber;
at least one primary check valve configured to enable passage of the hydraulic fluid in a single direction, from the reservoir to the piston chamber;
a push rod disposed to extend between the floating vessel and the unit housing of the power generation unit, whereby as the vessel moves in the at least one linear motion and the at least one rotational motion, the push rod is axially displaced in a reciprocating relationship with the vessel, in and out of the unit cavity of the power generation unit;
a piston disposed to extend in an axial relationship from the push rod to the chamber cavity of the piston chamber, the piston configured to be urged into the chamber cavity when the push rod is displaced into the unit cavity of the power generation unit, whereby displacement of the piston into the chamber cavity forcibly discharges the hydraulic fluid through the chamber outlet;
a hydraulic motor defined by a motor cavity, a motor inlet, and a motor outlet, the hydraulic motor configured to translate the flow of the hydraulic fluid into a mechanical action;
a generator disposed to operatively join with the hydraulic motor, the generator configured to translate the mechanical action of the hydraulic motor to an electrical energy;
a second conduit, the second conduit configured to carry the hydraulic fluid from the piston chamber to the hydraulic motor;
at least one secondary check valve configured to enable passage of the hydraulic fluid in a single direction, from the piston chamber to the motor inlet of the hydraulic motor;
a voltage regulator disposed to join with the generator, the voltage regulator configured to maintain the electrical energy at a substantially constant voltage;
a battery disposed to operatively connect to the voltage regulator, the battery configured to be charged by the electrical energy;
a third conduit configured to carry the hydraulic fluid from the hydraulic motor to the reservoir;
a platform; and
an arm defined by a first end and a second end, the first end disposed to pivotally join with the unit housing of the power generation unit, the second end disposed to fixedly join with the platform, the arm configured to pivotally articulate in relation to the vessel.

2. The assembly of claim 1, wherein the vessel includes at least one member selected from the group consisting of: a boat, a sail boat, a ship, a submarine, and a marine dock.

3. The assembly of claim 1, wherein the at least one linear motion comprises a heave, a sway, and a surge.

4. The assembly of claim 1, wherein the at least one rotational motion comprises a pitch, a roll, and a yaw.

5. The assembly of claim 1, wherein the power generation unit is configured to form a closed loop system.

6. The assembly of claim 1, wherein the at least one buoyant member is an evacuated cavity.

7. The assembly of claim 1, wherein the at least one buoyant member comprises two spaced-apart evacuated cavities.

8. The assembly of claim 1, wherein the ballast comprises a ballast inlet configured to receive a liquid.

9. The assembly of claim 1, wherein the unit housing of the power generation unit comprises a plurality of fastening pegs.

10. The assembly of claim 1, further comprising a hull mounting bracket, the hull mounting bracket configured to join the vessel with the pivot connection and the push rod.

11. The assembly of claim 10, wherein the hull mounting bracket comprises a bracket extension member.

12. The assembly of claim 11, wherein the hull mounting bracket comprises a plurality of apertures configured to receive a fastener.

13. The assembly of claim 12, wherein the plurality of apertures of the hull mounting bracket are configured to align with the plurality of fastening pegs of the unit housing.

14. The assembly of claim 1, wherein the third conduit is configured to receive the hydraulic fluid from the first chamber outlet and the second chamber outlet.

15. The assembly of claim 1, wherein the voltage regulator is a direct current voltage boost regulator.

16. An assembly for converting linear and rotational motions of a floating vessel into electrical energy, the assembly comprising:
a vessel defined by a generally buoyant configuration, the vessel configured to move in at least one linear motion and at least one rotational motion associated with buoyancy;
a power generation unit defined by a unit housing and a unit cavity, the power generation unit disposed to operatively join with the vessel, the power generation unit configured to enable conversion of the at least one linear motion and the at least one rotational motion of the vessel into electrical energy;
a pivot connection disposed to pivotally join the power generation unit to the vessel, the pivot connection configured to enable the power generation unit to pivotally move in a reciprocating manner relative to the vessel;
a ballast disposed to join with the unit housing of the power generation unit, the ballast configured to receive a liquid, whereby the liquid weighs the ballast to a predetermined weight that maintains the power generation unit in a generally balanced relationship with the vessel;
at least one buoyant member disposed to join with the unit housing, the at least one buoyant member configured to enable buoyancy of the power generation unit, whereby the buoyancy of the at least one buoyant member opposes the predetermined weight of the ballast;
a reservoir disposed in the unit cavity, the reservoir defined by a reservoir cavity, a reservoir inlet, and a reservoir outlet, the reservoir cavity configured to contain a hydraulic fluid;
a piston chamber defined by a chamber cavity, a chamber inlet, and a first chamber outlet, and a second chamber outlet, the piston chamber in communication with the reservoir;
a first conduit configured to carry the hydraulic fluid from the reservoir to the piston chamber;
at least one primary check valve configured to enable passage of the hydraulic fluid in a single direction, from the reservoir to the piston chamber;
a push rod disposed to extend between the floating vessel and the unit housing of the power generation unit, whereby as the vessel moves in the at least one linear motion and the at least one rotational motion, the push rod is axially displaced in a reciprocating relationship with the vessel, in and out of the unit cavity of the power generation unit;
a piston disposed to extend in an axial relationship from the push rod to the chamber cavity of the piston chamber, the piston configured to be urged into the chamber cavity when the push rod is displaced into the unit cavity of the power generation unit, whereby displacement of the piston into the chamber cavity forcibly discharges the hydraulic fluid through the chamber outlet;
a hydraulic motor defined by a motor cavity, a motor inlet, and a motor outlet, the hydraulic motor configured to translate the flow of the hydraulic fluid into a mechanical action;
a generator disposed to operatively join with the hydraulic motor, the generator configured to translate the mechanical action of the hydraulic motor to an electrical energy;
a second conduit, the second conduit configured to carry the hydraulic fluid from the piston chamber to the hydraulic motor;
at least one secondary check valve configured to enable passage of the hydraulic fluid in a single direction, from the piston chamber to the motor inlet of the hydraulic motor;
a voltage regulator disposed to join with the generator, the voltage regulator configured to maintain the electrical energy at a substantially constant voltage;
a battery disposed to operatively connect to the voltage regulator, the battery configured to be charged by the electrical energy; and
a third conduit configured to carry the hydraulic fluid from the hydraulic motor to the reservoir.

17. The assembly of claim 1, further comprising a platform.

18. The assembly of claim 17, further comprising an arm defined by a first end and a second end, the first end disposed to pivotally join with the unit housing of the power generation unit, the second end disposed to fixedly join with the platform, the arm configured to pivotally articulate in relation to the vessel.

19. The assembly of claim 1, further comprising a hull mounting bracket, the hull mounting bracket configured to join the vessel with the pivot connection and the push rod.

20. The assembly of claim 19, wherein the hull mounting bracket comprises a bracket extension member.
